(19) United States
(12) Patent Application Publication
(10) Pub. No.: US 2014/0115503 A1
(43) Pub. Date: Apr. 24, 2014

(54) USER INTERFACE ELEMENT-BASED DEVELOPMENT

(71) Applicant: Prashant Mishra, Redmond, WA (US)

(72) Inventor: Prashant Mishra, Redmond, WA (US)

(21) Appl. No.: 13/658,633

(22) Filed: Oct. 23, 2012

(51) Int. Cl. G06F 3/048

(52) U.S. Cl. 715/760; 715/762

(57) ABSTRACT

The instant application discloses, among other things, techniques to allow simplified user interface element-based development, allowing users unskilled in conventional programming languages to produce applications by setting attributes, layout, and behaviors for user interface element.

### FIELD

This disclosure relates to User Interface Element-Based Development.

### BACKGROUND

As computers become more powerful and user interfaces evolve, consistency becomes more and more important. For example, Microsoft Windows 8 (™ Microsoft) uses User Interface (UI) Elements on screen called “tiles” to provide a common way to access functionality from different applications.

UI Element-based applications are general written in C#, C++, Visual Basic, or other conventional programming languages.

### SUMMARY

The instant application discloses, among other things, techniques to allow simplified UI Element-Based Development, allowing users unskilled in conventional programming languages to produce applications, optionally using a touch interface.

A set known as a template may consist of UI Elements, which may have display attributes, behaviors, and links to other UI Elements or templates. Web pages, web parts, mobile applications, scorecards, such as Balanced Scorecard (BSC), dashboards such as key performance indicators (KPI), PowerPoint®, blueprints, prototypes, or other types of applications or devices may be targeted.

Standards for layout may also help provide consistency for end users, and templates may be designed to enforce UI design standards or best practices.

### BRIEF DESCRIPTION OF THE DRAWINGS

FIG. 1 is an example of a system on which UI Element-Based Development may be implemented according to one embodiment.

FIG. 2 is an example of a scorecard developed using UI Element-Based Development according to one embodiment.

FIG. 3 illustrates an example of inputs that may be used for a UI Element.

FIG. 4 illustrates an example of a set of UI Elements with various inputs and display attributes.

FIG. 5 illustrates a Property Window according to one embodiment.

FIG. 6 is an example of a system on which UI Element-Based Development may be implemented according to another embodiment.

FIG. 7 is an example of a scorecard developed using UI Element-Based Development according to another embodiment.

FIG. 8 is an example of a scorecard developed using UI Element-Based Development according to yet another embodiment.

FIG. 9 is an example of a scorecard developed using UI Element-Based Development according to yet another embodiment.

FIG. 10 illustrates a component diagram of a computing device according to one embodiment.

### DETAILED DESCRIPTION

A more particular description of certain embodiments of UI Element-Based Development may be had by references to the embodiments shown in the drawings that form a part of this specification, in which like numerals represent like objects.

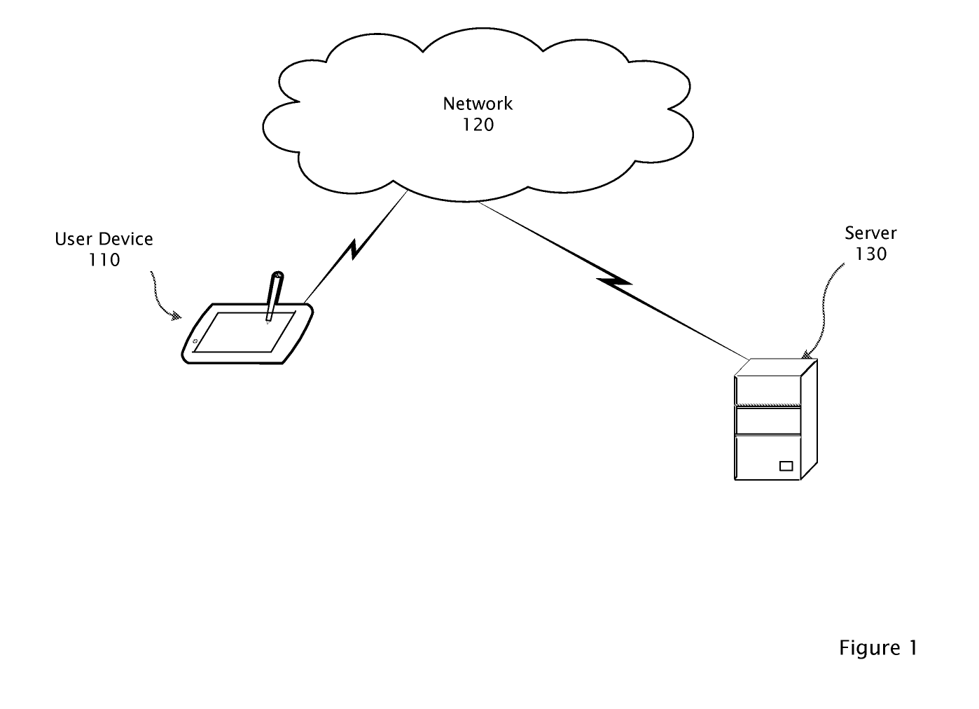

FIG. 1 is an example of a system on which UI Element-Based Development may be implemented. A user may design UI Element-Based Application on User Device 110. Software supporting UI Element-Based Development may be local to User Device 110, or may be hosted on Server 130. Various types of software may be used for UI Element-Based Development, including but not limited to native software running on User Device 110, client-server server software running on User Device 110 and Server 130, or software running on Server 130 and serving web pages to User Device 110. In this example, User Device 110 may be used to originate a request for UI Element-Based Development to be performed and send it via Network 120 to Server 130. Network 120 may be a local area network, or it may include the Internet. Any type of communication link may be used, or all processing may occur on one device. Other types of data transfer may also be used, such as loading information from User Device 110 onto a portable drive and loading the information onto Server 130.

Server 130 may include one or more computers, and may serve a number of roles, including, but not limited to, storing content and attributes, manipulating content and attributes, and serving content. For example, in one embodiment, Server 130 may include a database with tables to store information about users, user devices, projects, articles, content elements, layouts, layout definitions, and other data that may be relevant to User Interface Element-Based Development.

One skilled in the art will recognize that User Device 110 and Server 130 may be of different designs and capabilities.

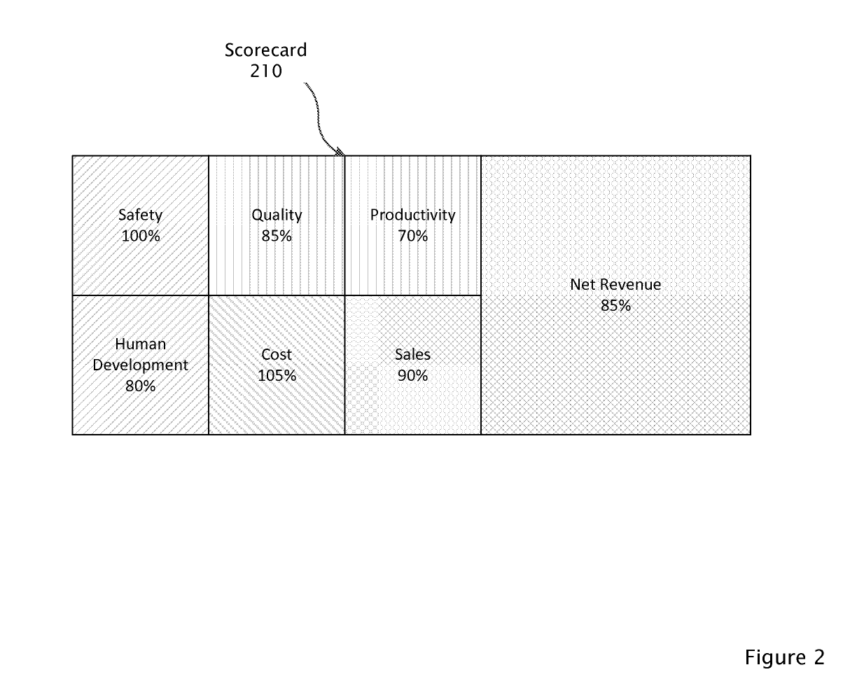

FIG. 2 is an example of a scorecard developed using UI Element-Based Development according to one embodiment. In this example, UI Elements are illustrated for Safety, Quality, Productivity, Human Development, Cost, Sales, and Net Revenue. The UI Elements may indicate a percentage of a goal for each metric displayed. In this example, Safety is 100% of goal, Quality 85%, Productivity 70%, Human Development 80%, Cost 105%, Sales 90%, and Net Revenue 85%.

A one or more UI Elements may be combined in a template. A template for a scorecard, for example, may be reused for any number of scorecards with different data sources. Other templates may include UI Elements for other topics, or may be a set of UI Elements a user wants to use. Templates may store any attributes about each of the UI Elements, including height, width, shape, style, content, data source, position, behaviors, or any other attributes the UI Element supports.

A template may be run, where the UI Elements will respond to events and run behaviors, during design. A runtime environment may include an interpreter to execute various behaviors when UI Elements are selected.

Standards may be enforced to provide a consistent appearance for templates. Standards may apply to any attributes UI Elements support, as well as attributes of templates such as the distance between UI Elements, which types of UI Elements may be displayed, or any other attributes relevant to a template. Standards may be developed by a user who designed a template, by administrators of a server hosting the template, by software hosting the template (such as Microsoft Windows®), by a stakeholder of the template, or by any other interested party.

In one embodiment, a UI Element may be selected and placed by selecting it from a list, selecting a template containing one or more UI Elements, or dragging and dropping from a source. One having skill in the art will recognize that any way of designing layouts maybe used in other embodiments.

UI Elements may have different shapes and sizes. In this example, UI Elements are rectangular tiles, but in other embodiments, they may be square, rectangular, round, oval, triangular, or other shapes. Shapes may also be mixed within an application.

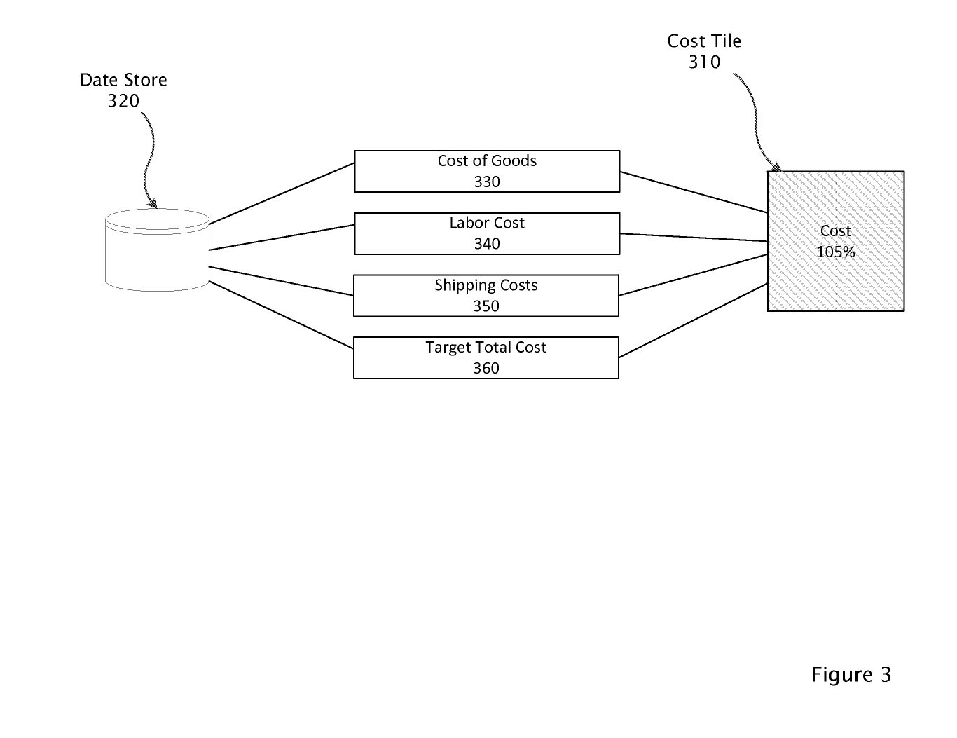

FIG. 3 illustrates an example of inputs that may be used for a UI Element. In this example, a Cost UI Element 310 may obtain data from a Data Store 320, and use these data to determine what to display. Cost of Goods 330, Labor Cost 340, and Shipping Costs 350 may contribute to the overall cost of an item. In view of these and a Target Total Cost 360, Cost UI Element 310 may calculate and display a percentage of the target cost (in this example 105%), it may display a color such as red, yellow, or green, depending on preset limits and the calculated percentage, or it may provide other indicators.

UI Elements may respond to actions, which may include touching, clicking, dragging, selecting, double clicking, stretching, zooming, grouping, or any other ways to interact with UI Elements.

In this example, Cost UI Element 310 is square, but in another embodiment, a UI Element could be a different shape. In yet another embodiment, a UI Element may also be dynamic, with what is displayed changing over time.

In one embodiment, the attributes of a UI Element may be data driven. In this embodiment, attributes related to data may include size, shape, color, image, video, connections to other UI elements, actions, behaviors, or any other attributes. As an example, data may include information about an organizational structure. UI Elements may be displayed reflecting the information, with connections illustrating the organizational structure. Other related data items may also have connectors automatically included on corresponding UI Elements.

UI Elements may also host other UI Elements. For example, a scorecard UI Element may display several bars displaying various data which are included in an aspect of the scorecard.

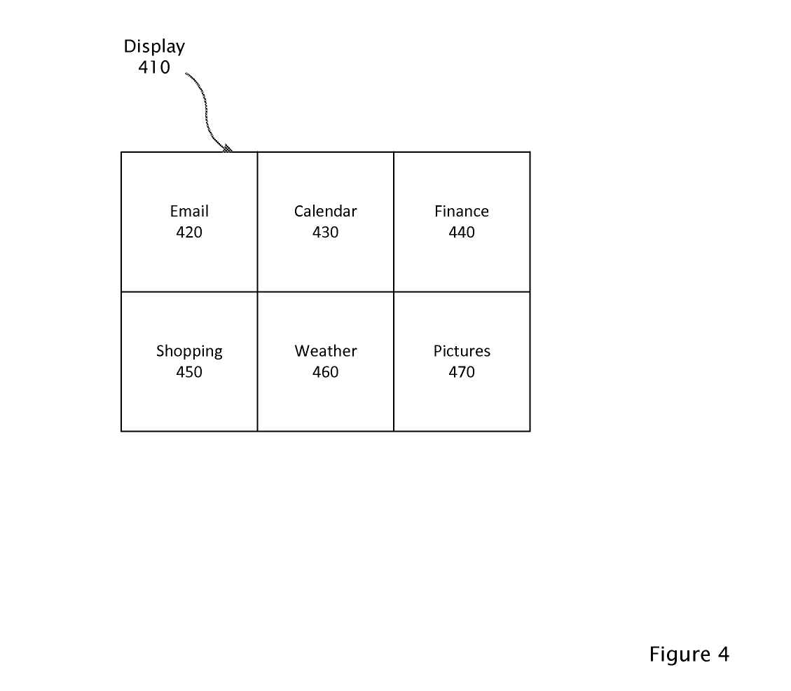

FIG. 4 illustrates an example of a set of UI Elements with various inputs and display attributes. Display 410 may display UI Elements for email 420, Calendar 430, Finance 440, Shopping 450, Weather 460, and Pictures 470.

Email UI Element 420 may display a static image of a latest email. It may also have a dynamic display with scrolling email. Email UI Element 420 may change colors depending on attributes of email it is displaying; for example, it may change colors based on who sent the email, or based on an urgent flag for the email. One having skill in the art will recognize that many different behaviors may be performed by a UI Element to indicate attributes of its content.

Calendar UI Element 430 may show meetings, appointments, or other time-based events, again with various attributes based on the content displayed. For example, the color of Calendar UI Element 430 may change as a meeting time draws near, or a birthday reminder may get a colorful pattern, or a sound may be played.

Finance UI Element 440 may show the biggest movers of a user's portfolio. Increases and decreases may have different colors. Again, many different attributes may be used to indicate information about content.

Pictures UI Element 470 may display a static picture, or may display a slide show of a selection of pictures.

One having skill in the art will recognize that a UI Element may provide information using many different attributes, actions, or features, including, but not limited to, text, images, videos, colors, patterns, movement, and sounds.

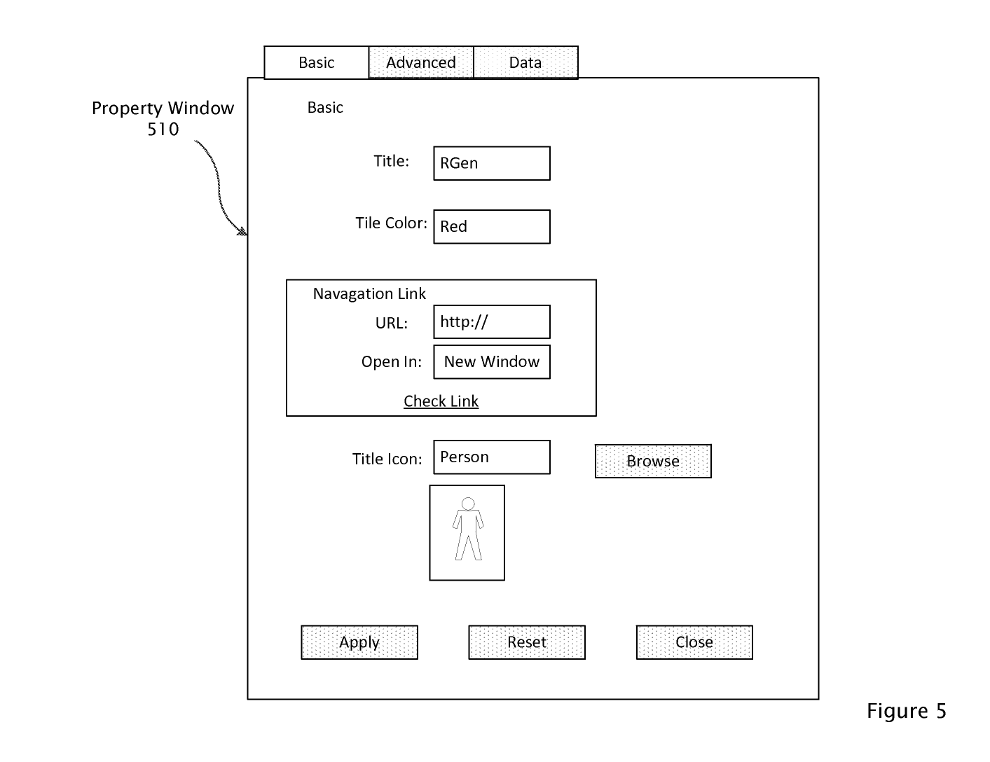

FIG. 5 illustrates a Property Window 510 according to one embodiment. Property Window 510 may have multiple tabs; in this example there are three tabs: Basic, Advanced, and Data.

The Basic tab is shown, having prompts and text boxes to allow the setting of various properties (attributes) of a UI Element. In this example, the UI Element has a title with the value of RGen, a title color of red, and a title icon named “Person,” which is a symbol of a person. The ability to browse to select an icon is available. There is also a behavior with a URL which will open in a new window when the UI Element is clicked.

Once a property is set, a user may click the Apply, Reset, or Close buttons, which applies a property change to the UI Element, resets the properties to previous values, or close the Property Window 510 respectively.

Other tabs may provide different properties, which may be typed, selected form a list, browsed to, or any other way of selecting them.

One having skill in the art will recognize that properties may have many different ways of being set and tested, and that there may be different UI designs to allow setting properties.

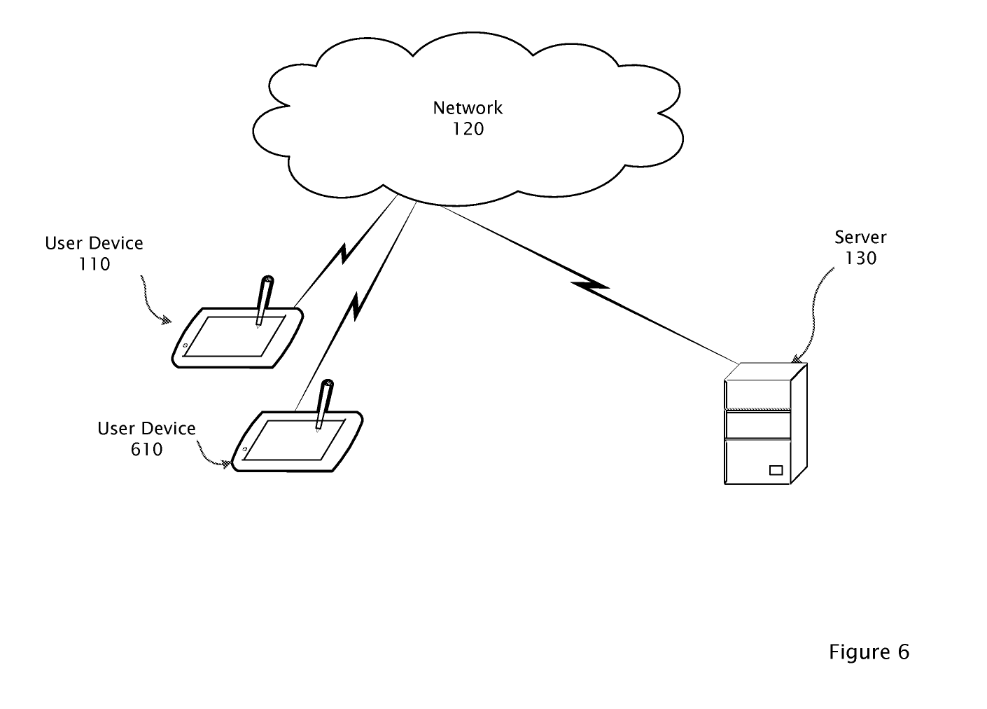

FIG. 6 is an example of a system on which UI Element-Based Development may be implemented according to another embodiment. User Device 610 may be used to view an output from UI Element-Based Development. A user may design UI Element-Based Application on User Device 110. The developed application may be stored on Server 130. In one embodiment, User Device 610 may run software allowing it to view UI Element-Based Applications natively. User Device 610 or Server 130 may allow searching for

In another embodiment, User Device 110 or Server 130 may export UI Element layouts and attributes as HTML, which User Device 610 may use a web browser to view. In other embodiments, User Device 110 or Server 130 may export UI Element layouts and attributes as SharePoint® web parts, or PowerPoint® or other presentation software slides. One having skill in the art will recognize that there are many formats to which UI Element layouts and attributes may be exported. Some formats may allow interactivity, while others may provide a static image.

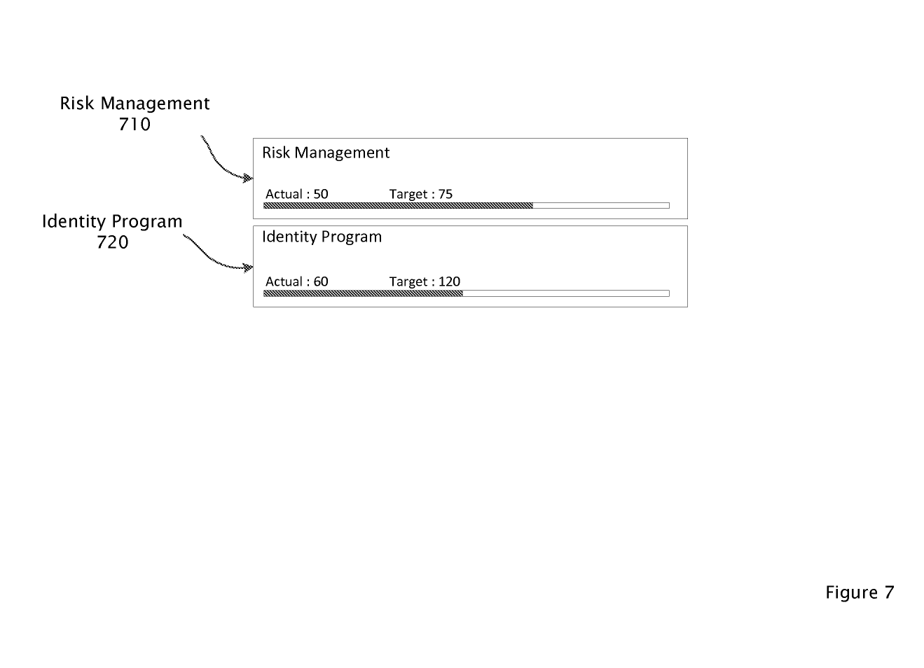

FIG. 7 is an example of a scorecard developed using UI Element-Based Development according to another embodiment. In this example, a progress bar may be used to illustrate a difference between an actual result and a target. Risk Management Tile 710 illustrates an Actual value of 50 and a Target value of 75, with a progress bar approximately two-thirds filled. Similarly, Identity Program Tile 720 shows an Actual value of 60 and a Target of 120, with a progress bar halfway filled.

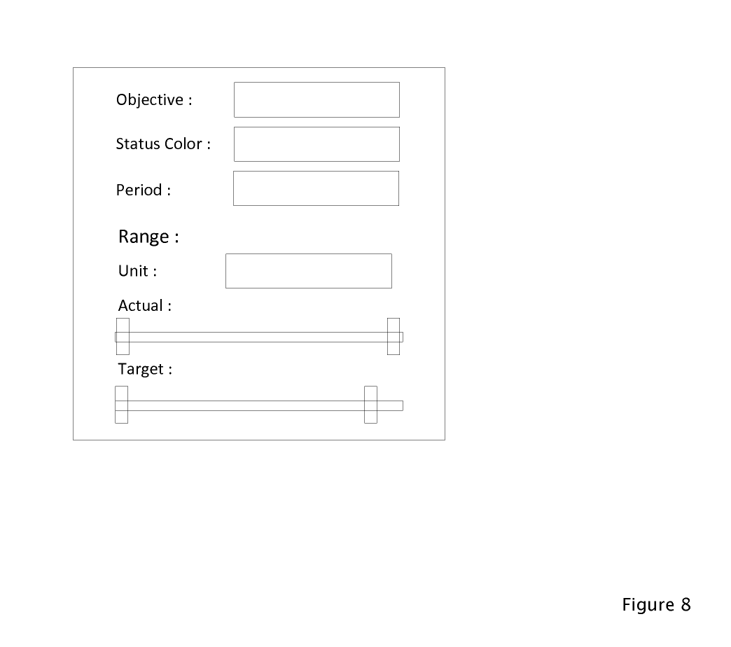

FIG. 8 is an example of a scorecard filter, using UI Element-Based Development according to yet another embodiment. In this example, a property window may be used to provide filtering and formatting for a scorecard. Various properties, including an objective, a status color, a period the scorecard is for, a range of values, and the upper and lower limit desired within the range may be set. These properties may then apply to other UI Elements making up a scorecard.

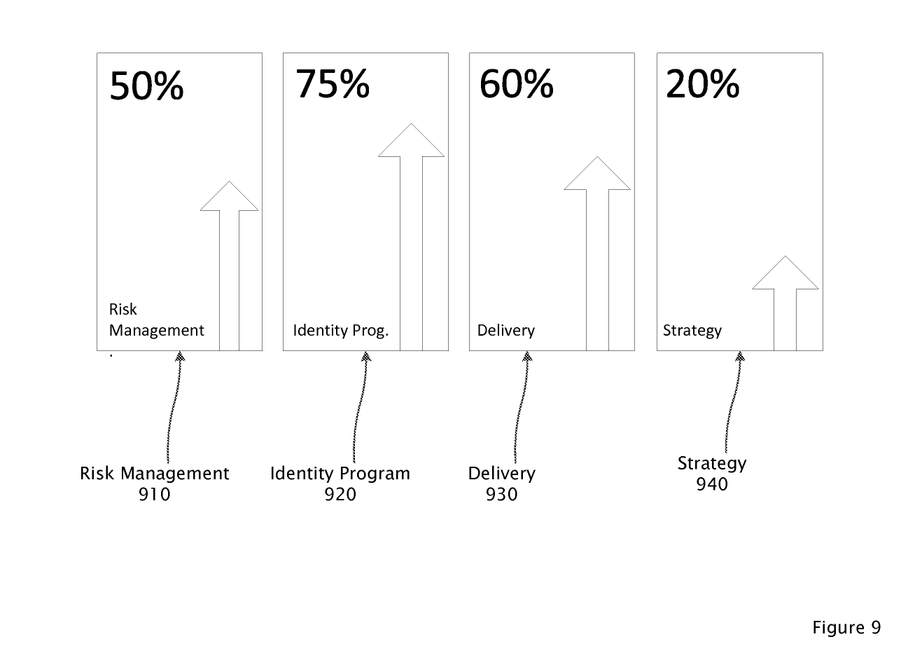

FIG. 9 is an example of a scorecard developed using UI Element-Based Development according to yet another embodiment. In this example, user interface elements for Risk Management 910, Identity Program 920, Delivery 930, and Strategy 940 illustrate respective values with percentages and arrows.

One having skill in the art will recognize that there are many different formats of scorecards, with many different possible values, which may be designed, displayed, and executed using User Interface Element-Based Development.

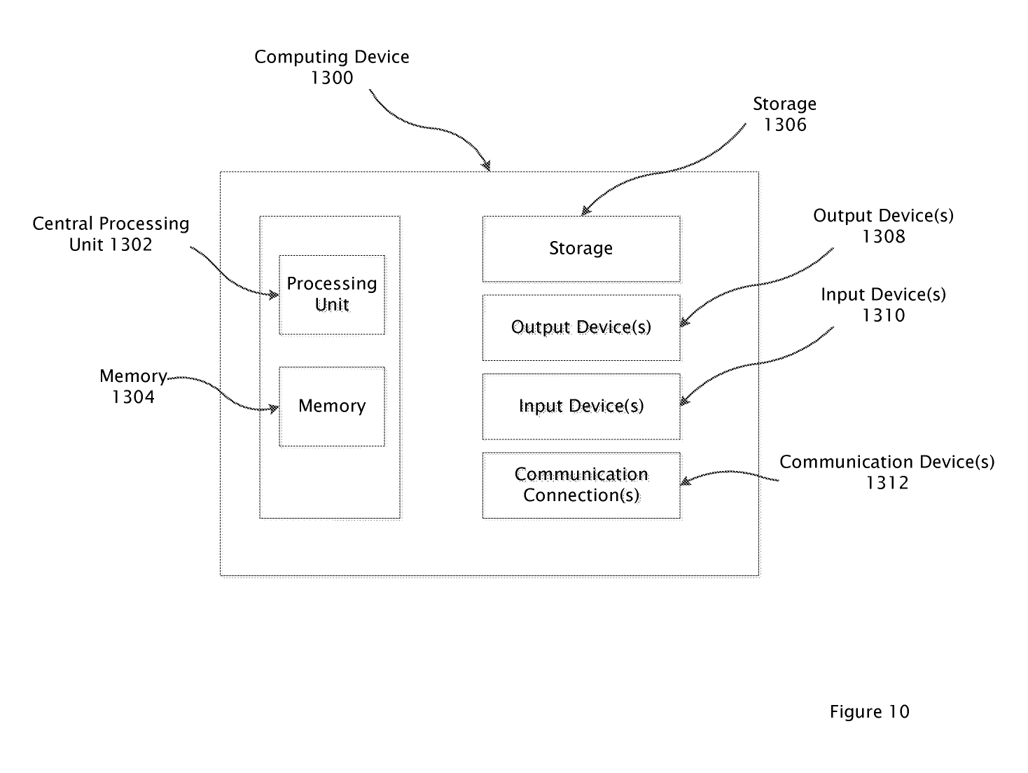

FIG. 10 illustrates a component diagram of a computing device according to one embodiment. The Computing Device (1300) can be utilized to implement one or more computing devices, computer processes, or software modules described herein, including, for example, but not limited to User Device 110, 610, or a Server 130. In one example, the Computing Device (1300) can be utilized to process calculations, execute instructions, receive and transmit digital signals. In another example, the Computing Device (1300) can be utilized to process calculations, execute instructions, receive and transmit digital signals, receive and transmit search queries, and hypertext, compile computer code as required by a User Device 110, 610 or a Server 130. The Computing Device (1300) can be any general or special purpose computer now known or to become known capable of performing the steps and/or performing the functions described herein, either in software, hardware, firmware, or a combination thereof.

In its most basic configuration, Computing Device (1300) typically includes at least one Central Processing Unit (CPU) (1302) and Memory (1304). Depending on the exact configuration and type of Computing Device (1300), Memory (1304) may be volatile (such as RAM), non-volatile (such as ROM, flash memory, etc.) or some combination of the two. Additionally, Computing Device (1300) may also have additional features/functionality. For example, Computing Device (1300) may include multiple CPU's. The described methods may be executed in any manner by any processing unit in computing device (1300). For example, the described process may be executed by both multiple CPU's in parallel.

Computing Device (1300) may also include additional storage (removable and/or non-removable) including, but not limited to, magnetic or optical disks or tape. Such additional storage is illustrated in FIG. 5 by Storage (1306). Computer storage media includes volatile and nonvolatile, removable and non-removable media implemented in any method or technology for storage of information such as computer readable instructions, data structures, program modules or other data. Memory (1304) and Storage (1306) are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer storage media may be part of computing device (1300).

Computing Device (1300) may also contain Communications Device(s) (1312) that allow the device to communicate with other devices. Communications Device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer storage media and communication media. The described methods may be encoded in any computer-readable media in any form, such as data, computer-executable instructions, and the like.

Computing Device (1300) may also have Input Device(s) (1310) such as keyboard, mouse, pen, voice input device, touch input device, etc. Output Device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A system, comprising:
a processor;
a memory coupled to the processor;
components operable by the processor, comprising:
a user interface element template receiving component, configured to receive one or more user interface element templates;
a user interface element template selection component, configured to select a user interface element template;
a user interface element attribute setting component, configured to allow setting an attribute for a user interface element from the selected template;
a display component, configured to display user interface elements from the selected template; and
a user interface element-based application sending component, for sending a user interface element-based application
a runtime component, configured to interpret and execute behaviors corresponding to actions.

2. The system of claim 1 wherein the user interface element template selection component is accessed through a touch interface.

3. The system of claim 1 wherein the user interface element attribute setting component is accessed through a touch interface.

4. The system of claim 1, wherein user interface element attribute setting component is hosted in a native application.

5. The system of claim 1, wherein user interface element attribute setting component is hosted in a native application.

6. The system of claim 1, wherein user interface element attribute setting component is hosted in a web browser.

7. The system of claim 1, wherein the attribute is selected from a group comprising: size, colors, shape, data source, text, image, video, and behavior.

8. The system of claim 1, wherein the user interface elements are tiles.

9. A system, comprising:
a user interface element-based application receiving component, configured to receive a user interface element-based application; and
a user interface element-based application user interface export component, configured to export a user interface element-based application user interface to display software.

10. The system of claim 9, wherein the display software is selected from a group comprising: presentation software, collaboration software, scorecard software, dashboard software, and web browser software.

11. The system of claim 9, further comprising:
a user interface element-based application storing component, configured to store a user interface element-based application;
a search criterion receiving component, configured to receive search criterion for finding a user interface element-based application; and
a user interface element-based application search component, configured to search for a user interface element-based application corresponding to the search criterion.

12. A computer-operable method, comprising:
selecting a user interface element; and
setting an attribute for the selected user interface element by updating a default value.

13. The method of claim 12 wherein the selecting a user interface element comprises clicking on the element.

14. The method of claim 12 wherein the selecting a user interface element is done using a touch interface.

15. The method of claim 12 wherein the attribute is selected from a group comprising: title, color, behavior, icon, image, video, position, size, and data source.

16. The method of claim 15 wherein behavior is selected from a group comprising: navigating to a url; calculating a value; changing an attribute; opening an application; opening a file for viewing; and opening a file for editing.
